(19) United States
(12) Patent Application Publication
(10) Pub. No.: US 2011/0068196 A1
(43) Pub. Date: Mar. 24, 2011

(54) CLEANING TOOL

(75) Inventor: Stephen John Flasch, Forest Lake, MN (US)

(73) Assignee: Green Bay Converting, Inc., Green Bay, WI (US)

(21) Appl. No.: 12/824,794

(22) Filed: Jun. 28, 2010

Related U.S. Application Data
(63) Continuation of application No. 11/825,134, filed on Jul. 3, 2007, now Pat. No. 7,743,947.
(60) Provisional application No. 60/811,130, filed on Jul. 5, 2006.

(51) Int. Cl. B05B 15/00; B23P 17/04

(52) U.S. Cl. 239/289; 239/302; 137/15.01

(57) ABSTRACT

The present disclosure provides an integrated spray and wipe system. A method of using such a system is also provided. In one embodiment, the system includes a fluid reservoir that extends through the center of a roll of cleaning material (e.g., paper towel roll). The tool houses cleaning fluid and cleaning wipes and therefore can be used to dispense liquid or cleaning wipes as needed.

### CROSS REFERENCE TO RELATED APPLICATIONS

The present application is a continuation of U.S. patent application Ser. No. 11/825,134 titled CLEANING TOOL, filed May 6, 2008, which claims the benefit of U.S. Provisional Patent Application Ser. No. 60/811,130 titled SPRAY N' DRY PAPER TOWEL, TRIGGER SPRAYER, DISPENSER STAND AND/OR HOLDER, filed Jul. 5, 2006, which applications are hereby incorporated by reference in their entirety.

### TECHNICAL FIELD

A tool for spraying cleaning fluid and dispensing cleaning wipes and a method of using the same.

### BACKGROUND

Spray bottles for spraying cleaning fluids are known. Cleaning wipe dispensers are also known. Typically, spray bottles and cleaning wipe dispensers are separate stand alone devices. Non-integrated spray and wipe devices can be difficult to transport and use in the field. An integrated spray and wipe system that would be easier to use and transport is desirable.

### SUMMARY

An embodiment of the present disclosure provides an integrated spray and wipe system. A method of using such a system is also provided. In one embodiment, the system includes a fluid reservoir that extends through the center of a roll of cleaning material (e.g., paper towel roll). The tool houses cleaning fluid and cleaning wipes and therefore can be used to dispense liquid or cleaning wipes as needed.

### BRIEF DESCRIPTION OF THE DRAWINGS

FIG. 1 is a perspective view of an embodiment of the cleaning tool in accordance with the present disclosure;

FIG. 2 is a perspective assembly view of the cleaning tool of FIG. 1;

FIG. 3 is a first side view of the housing of the cleaning tool of FIG. 1;

FIG. 4 is a second side view of the housing of the cleaning tool of FIG. 1;

FIG. 5 is a top perspective view of the housing of the cleaning tool of FIG. 1;

FIG. 6 is a bottom perspective view of the housing of the cleaning tool of FIG. 1;

FIG. 7 is a first side view of the reservoir of the cleaning tool of FIG. 1; and

FIG. 8 is a top perspective view of the reservoir of the cleaning tool of FIG. 1.

### DETAILED DESCRIPTION OF THE PREFERRED EMBODIMENT

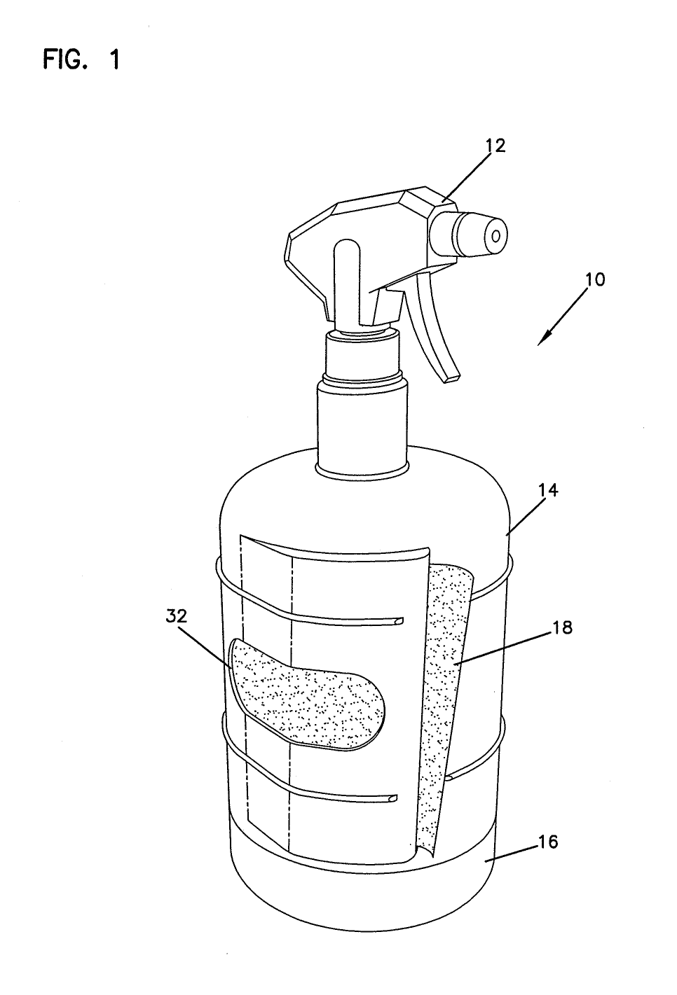

Referring to FIG. 1, a perspective view of an embodiment of a cleaning device according to the present disclosure is shown. The cleaning device 10 includes a spray head 12 for distributing cleaning fluid, a housing 14 for housing a cleaning material 18 (e.g., a roll or cube of paper towels, glass wipes, cleaning cloths, etc.), and a reservoir 16 for containing fluid (e.g., cleaning chemicals). FIG. 1 depicts the cleaning device 10 with the housing 14 loaded with a cleaning material 18. The cleaning material in the depicted embodiment is a roll of paper towels. However, it should be appreciated that many alternative forms and types of cleaning material are also possible.

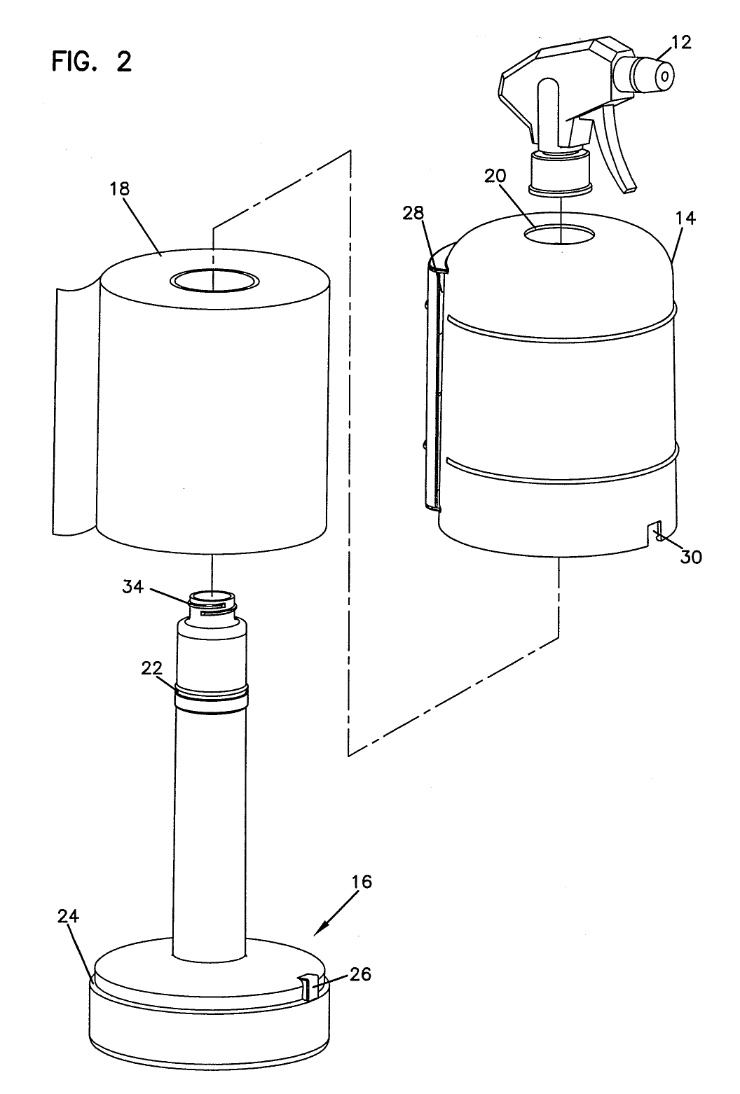

Referring to FIG. 2, the cleaning device 10 is shown in an exploded assembly view. To load the cleaning device 10 with cleaning materials 18 the spray head 12 and the reservoir 16 are disconnected. In the depicted embodiment the spray head 12 and the reservoir 16 are connected via threads. Disconnecting the spray head 12 from the reservoir 16 involves rotating the spray head 12 and reservoir 16 relative to each other. In the depicted embodiment the housing 14 is positioned between the spray head 12 and the reservoir 16. The lower end of the housing 14 is shown contacting the base of the reservoir 16 and the upper end of the housing 14 is shown contacting the neck of the reservoir 16.

More particularly, in the depicted embodiment the neck of the reservoir 16 extends through an aperture 20 at the top end of the housing 14. The neck of the reservoir 16 includes a channel 22 that supports the top end of the housing 14. The channel 22 is one of many means to secure the housing 14. For example, in an alternative embodiment the device 10 can be configured such that the housing 14 is secured by connecting the spray head 12 to reservoir 16.

In the depicted embodiment, the lower end of the housing 14 is seated in a radial shelf 24 disposed along the base of the reservoir 16. The shelf includes a tab 26 that orients the housing 14 relative to the reservoir 16. In the depicted embodiment the housing 14 and the lower end of the reservoir 16 are generally cylindrically shaped. Moreover, the outer diameter of the lower end of the housing 14 is generally the same as the diameter of the base of the reservoir 16. It should be appreciated that in alternative embodiments the housing and the base can be of different shapes, and the housing and the base can connect in different ways. For example, the housing could thread to the base, fit within grooves on the base, or snap over the base.

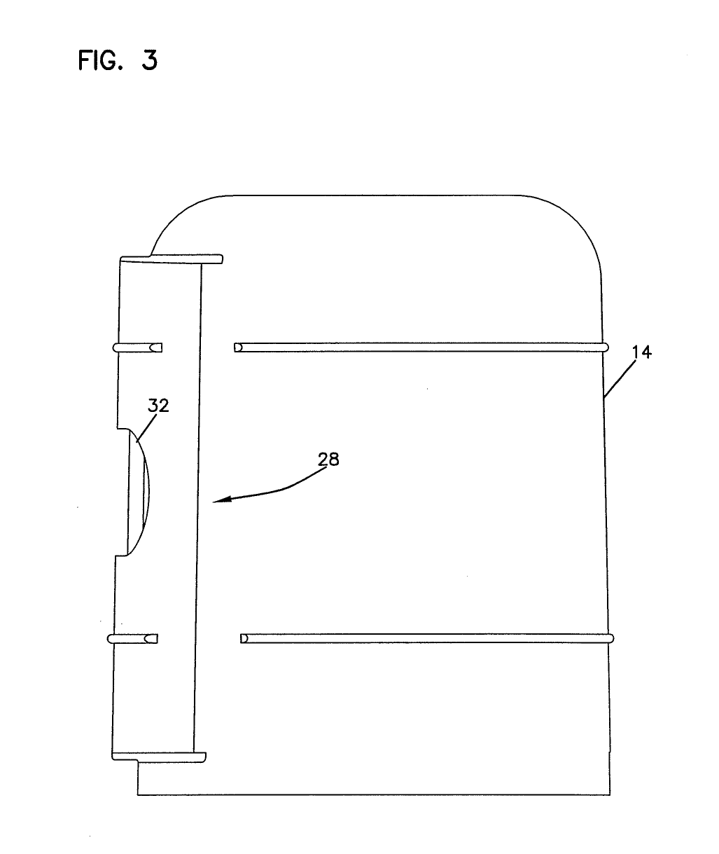

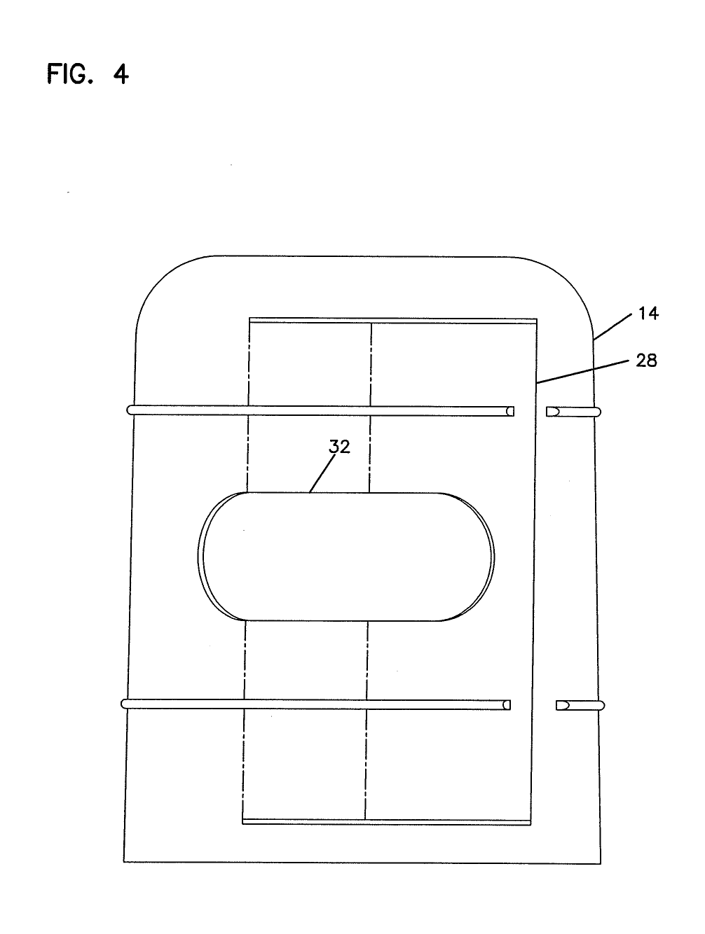

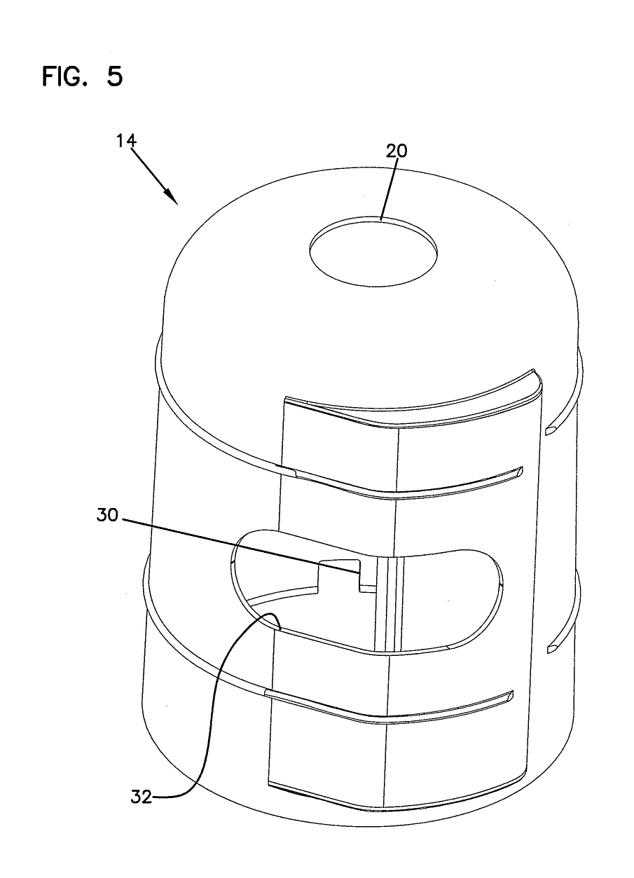

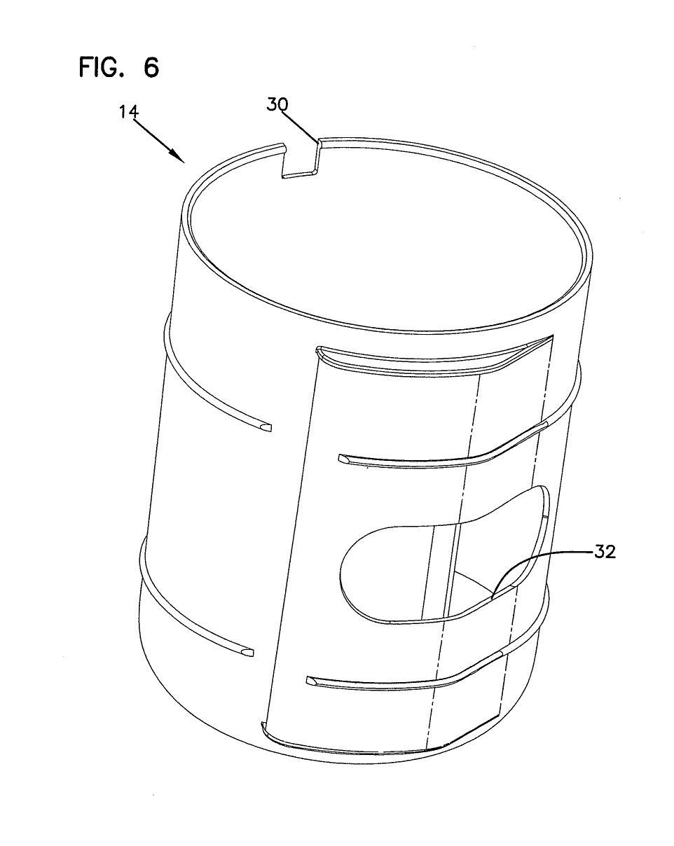

Referring to FIGS. 3-6 an embodiment of the housing 14 is shown. In the depicted embodiment the upper end of the housing 14 is a single integrated component of the device 10. It should be appreciated that in alternative embodiments the housing 14 could be integrally formed with the reservoir 16, or the housing 14 could comprise a number of separate parts that can be connected together. For example, in alternative embodiments the upper end of the housing could be a separate cap that connects to the body of the housing 14. In the depicted embodiment the upper portion of the housing 14 includes a generally domed-shaped portion having an aperture 20 therein for receiving the neck of the reservoir 16. The body of the housing 14 includes a side opening 28 for dispensing cleaning materials (e.g., paper towels on a roll). The lower end of the housing 14 is open and includes a notch 30 that locates the housing on the base of the reservoir 16.

In the depicted embodiment the side opening 28 includes a portion of the side walls of the housing that overlap. The overlapping portion includes an aperture 32 that makes it easier to access the cleaning material within the housing 14. The aperture 32 is configured such that a user can reach into the housing with his or her fingers and pull a portion of the cleaning material into the side opening 28. The side opening 28 of the depicted embodiment is configured to enable the user to tear off portions of the cleaning material if the cleaning material is in the form of a continuous sheet of material. For example if the cleaning material is on a roll that unwinds by pulling the sheet in a counterclockwise direction, the user can pull the material swiftly against the overlapping portion in a clockwise direction to tear off a portion of the cleaning material. In some embodiments the overlapping portion can include serrations to facilitate the tearing.

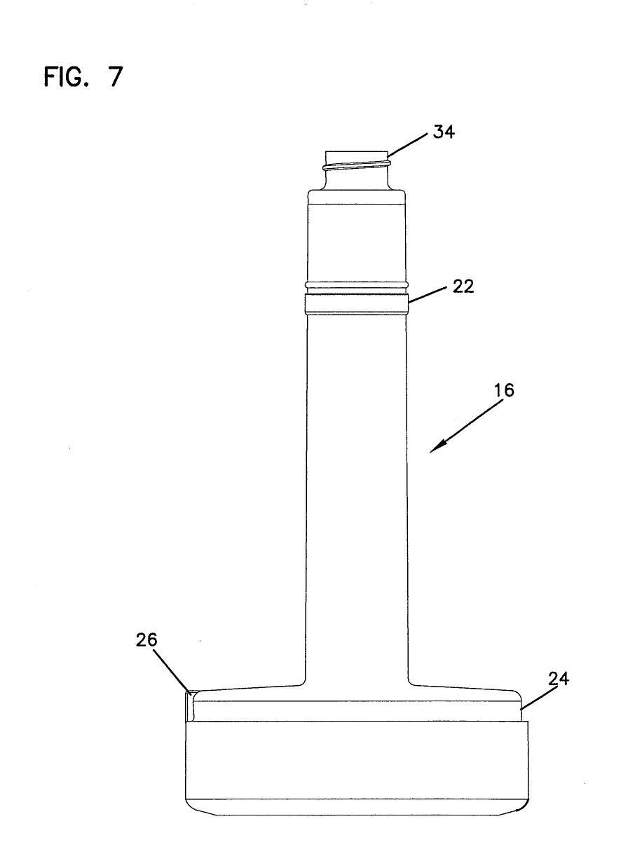

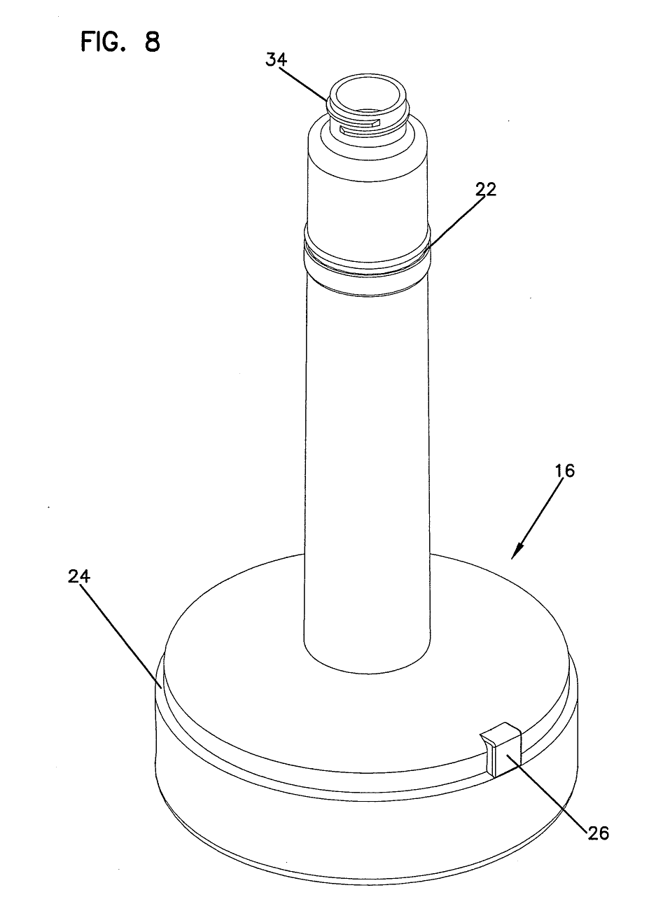

Referring to FIGS. 7-8, an embodiment of the reservoir 16 is shown. The reservoir 16 of the depicted embodiment includes a cylindrical base connected to a cylindrical neck. The upper end of the base includes an annular step that is configured to engage the bottom end of the housing 14. The upper end of the neck includes threads 34 that are configured to engage the spray head. A portion of the neck also include a channel 22 configured to engage the upper end of the housing 14. In the depicted embodiment the diameter of the largest portion of the neck is less than about 3 inches and the length of the neck is between 4-24 inches. The configuration enables the neck to slide into the center of rolls of cleaning materials. In the depicted embodiment the base of the reservoir has a diameter of between about 3 to about 12 inches. It should be appreciated that many alternative configurations and sizes of the reservoir 16 are possible.

In one embodiment, the cleaning device 10 can be loaded by pouring cleaning fluid into the neck of a reservoir 16, positioning cleaning material 18 (e.g., roll of cleaning drying wipes) around the neck of the reservoir 16, positioning a housing 14 around the roll of cleaning material 18, connecting a spray head to the neck of the reservoir (e.g., threading the spray head to the reservoir), and pulling a portion of the cleaning material 18 through an opening 28 in the housing 14. Once the device is loaded, cleaning liquid can be dispensed when the user squeezes the spray head and the cleaning materials (e.g., paper towels) can be dispensed by pulling out a section of cleaning material and tearing it off.

The above specification, examples, and data provide a complete description of the manufacture and use of the composition of the invention. Since many embodiments of the invention can be made without departing from the spirit and scope of the invention, the invention resides in the claims hereinafter appended.

We claim:

1. A cleaning device comprising:
a housing including a first end and a second end;
a spray head adjacent the first end of the housing; and
a reservoir including a base adjacent the second end of the housing, wherein the fluid reservoir is configured to supply fluid to the spray head.

2. The device of claim 1, wherein the reservoir includes a neck that extends through the housing and connects to the spray head.

3. The device of claim 2, wherein the neck of the reservoir is threaded to the spray head.

4. The device of claim 2, wherein the neck has a diameter of less than about 3 inches.

5. The device of claim 2, wherein the neck has a length of between about 4 inches and about 24 inches.

6. The device of claim 1, wherein the housing includes an aperture at the first end that engages a raised surface feature on the neck of the reservoir.

7. The device of claim 1, wherein the housing is generally cylindrical.

8. The device of claim 7, wherein the housing includes an overlapping side portion.

9. The device of claim 8, wherein the overlapping side portion includes an upper end portion, a lower end portion, and a mid portion, and wherein the mid portion includes an aperture therein.

10. The device of claim 1, wherein the base of the reservoir is generally cylindrical.

11. The device of claim 1, wherein the diameter of the base is between about 3 inches to about 12 inches.

12. A method of using a cleaning device comprising:
pouring cleaning fluid into the neck of a reservoir;
positioning a roll of cleaning material around the neck of the reservoir; and
connecting a spray head to the neck of the reservoir.

13. The method of claim 12, further comprising providing a housing around the roll of cleaning material.

14. The method of claim 13, further comprising pulling a portion of the cleaning material through an opening in the housing.

15. The method of claim 14, wherein the act of pulling a portion of the cleaning material through an opening in the housing rotates the roll of cleaning material about the neck of the reservoir.

16. The method of claim 12, further comprising squeezing the spray head to spray cleaning fluid on a surface.

17. The method of claim 16, further comprising tearing a section of cleaning material from the roll of cleaning material.

18. The method of claim 12, wherein the step of connecting the spray head to the neck includes threading the neck to the reservoir.

19. A cleaning system comprising:
a generally cylindrical housing including a first end and a second end and an overlapping side portion;
a roll of cleaning material within the housing;
a spray head adjacent the first end of the housing; and
a reservoir including a generally cylindrical base adjacent the second end of the housing and a neck extending from the base through the housing, wherein the fluid reservoir is configured to supply fluid to the spray head and wherein the neck is connected to the spray head.
